(19) United States
(12) Patent Application Publication
(10) Pub. No.: US 2005/0221804 A1
(43) Pub. Date: Oct. 6, 2005

(54) Call log management

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: PATTI & BRILL, ONE NORTH LASALLE STREET, 44TH FLOOR, CHICAGO, IL, 60602, US

(21) Appl. No.: 10/818,285

(22) Filed: Apr. 5, 2004

(51) Int. Cl. H04B 7/00; H04Q 7/20; H04M 3/42

(52) U.S. Cl. 455/414.1; 455/415

(57) ABSTRACT

A network component of an apparatus in one example allows a user of a mobile communication device to perform one or more management procedures on a log of one or more calls terminated to and/or originated by the mobile communication device.

### TECHNICAL FIELD

The invention relates generally to mobile phones and more particularly to mobile phone call logs.

### BACKGROUND

Mobile phone subscribers use their mobile phones for a wide range of reasons, including business, family, and personal purposes. In present systems, all calls to and from the mobile phone are recorded in a log. For example, when a user of the mobile phone dials a number to place a call, the number is stored in a log of dialed numbers. If the user has a caller ID service, then caller ID numbers for calls that are received by the mobile phone are stored as well. Numbers for business, family, and personal calls are stored in a single log. It is desirable to maintain privacy of the log on the mobile phone when the user lends their mobile phone to another person, or if the mobile phone is lost or stolen and recovered by another person. For example, the log may disclose confidential and/or personal information that the user wishes to keep private.

Thus, a need exists for an increase in privacy of logs of calls to and from mobile phones.

### SUMMARY

In one embodiment, there is provided an apparatus comprising a network infrastructure component that allows a user of a mobile communication device to perform one or more management procedures on a log of one or more calls terminated to and/or originated by the mobile communication device.

In another embodiment, there is provided a method for managing a log of one or more calls terminated to and/or originated by a mobile communication device through employment of a mobile subscriber database of a mobile communications network.

In yet another embodiment, there is provided an article comprising one or more computer-readable signal-bearing media. The article includes means in the one or more media for managing a log of one or more calls terminated to and/or originated by a mobile communication device through employment of a mobile subscriber database of a mobile communications network.

### DESCRIPTION OF THE DRAWINGS

Features of exemplary implementations of the invention will become apparent from the description, the claims, and the accompanying drawings in which:

FIG. 1 is a representation of one implementation of an apparatus that comprises a network infrastructure component, a mobile communication device, and a communication device.

FIG. 2 is a representation of an exemplary logic flow for the apparatus of FIG. 1 and illustrates creation of a log entry for an outgoing call.

FIG. 3 is a representation of an exemplary logic flow for the apparatus of FIG. 1 that illustrates a display of a call log.

### DETAILED DESCRIPTION

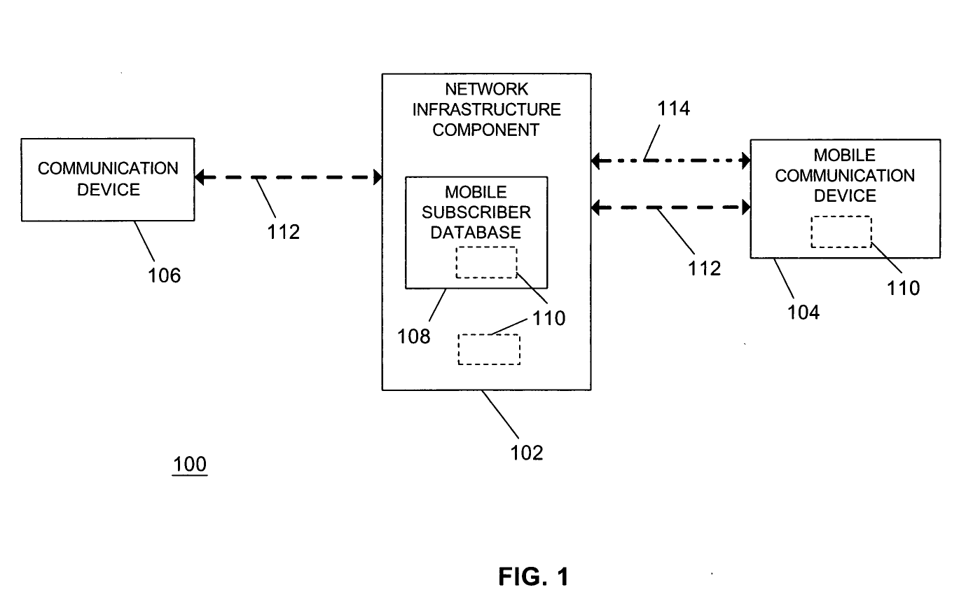

Turning to FIG. 1, an apparatus 100 in one example comprises a network infrastructure component 102, a mobile communication device 104, and a communication device 106. The network infrastructure component 102 in one example comprises a mobile switching center and/or application server of a mobile communications network (not shown). The network infrastructure component 102 in one example comprises a mobile subscriber database 108. In another example, the mobile subscriber database 108 is remotely located from the network infrastructure component 102. The network infrastructure component 102 and/or the mobile subscriber database 108 in one example comprise an instance of a recordable data storage medium 110, as described herein. The network infrastructure component 102 synchronizes with the mobile communication device 104. For example, the network infrastructure component 102 routes calls to and from the mobile communication device 104, as will be appreciated by those skilled in the art.

The mobile communication device 104 in one example comprises a mobile phone and/or personal digital assistant. In a further example, the mobile communication device 104 comprises an instance of the recordable data storage medium 110, as described herein. A user (not shown) of the mobile communication device 104 employs the mobile communication device 104 to place and receive calls. In one example, the user places a call to a user (not shown) of the communication device 106. In another example, the user of the mobile communication device 104 receives a call from the user of the communication device 106, as described herein.

The communication device 106 in one example comprises a terminal of a public switched telephone network, a telephony device, or another mobile communication device. The communication device 106 comprises an identifier, for example, a phone number, a mobile station ID, or an internet protocol address. In one example, the user of the mobile communication device 104 inputs the phone number of the communication device 106 to place a call to the user of the communication device 106. In another example, the user of the communication device 106 places a call to the user of the mobile communication device 104. If the mobile communication device 104 supports a caller ID feature, the identifier of the communication device 106 is communicated to the user of the mobile communication device 104. In a further example, the mobile communication device 104 communicates another identifier associated with the user of the communication device 106, for example, an email address, messaging protocol user name, or a user-defined nickname, such as “Home” or “Work.” Where the identifier comprises an email address or messaging protocol user name, the log comprises entries for email and/or instant messaging, as will be appreciated by those skilled in the art.

The user of the mobile communication device 104 places and/or receives one or more calls 112 through the network infrastructure component 102. The network infrastructure component 102, the mobile subscriber database 108, and/or the mobile communication device 104 in one example store one or more logs of one or more entries associated with the calls 112. For example, the network infrastructure component 102 and/or the mobile subscriber database 108 store the log in the recordable data storage media 110. The log in one example comprises one or more log portions, for example, an incoming call log portion and an outgoing call log portion, as will be appreciated by those skilled in the art.

The entries of the log in one example comprise one or more of the identifier of the communication device 106, a duration of the call, and/or other call parameters, as will be appreciated by those skilled in the art. The mobile communication device 104 in one example allows the user of the mobile communication device 104 to view and modify the log. In a further example, the network infrastructure component 102 allows the user to perform one or more management procedures on the log. The network infrastructure component 102 and the mobile communication device 104 in one example exchange one or more messages 114 to perform the management procedures on the log, as described herein.

The user of the mobile communication device 104 in one example employs the mobile communication device 104 to perform the management procedures. For example, the user inputs a digit sequence to initiate a procedure. Exemplary management procedures comprise activating the log, inserting an entry into the log, viewing the log, removing an entry from the log, deactivating the log, and clearing the log, as described herein.

An illustrative description of exemplary operation of the apparatus 100 is presented, for explanatory purposes. The user of the mobile communication device 104 in one example inputs a digit sequence, for example, “*3,” to activate the log. Upon initiation of a call, the network infrastructure component 102 in one example queries the mobile subscriber database 108 to determine an activation status of the log. If the log is activated, the network infrastructure component 102 creates an entry in the log for each call terminated to and/or originated by the mobile communication device 104. The user of the mobile communication device 104 in one example inputs another digit sequence to view the log. For example, the user inputs “*6” and the network infrastructure component 102 and the mobile communication device 104 cooperate to communicate the log to the user. The network infrastructure component 102 sends one or more messages that comprise the entries of the log to the mobile communication device 104. The mobile communication device 104 communicates the entries to the user through employment of a display screen or audio notification. The user of the mobile communication device 104 in one example selects one or more entries and inputs a digit sequence to remove the entries from the log. In another example, the user of the mobile communication device 104 inputs a digit sequence to clear all entries from the log. The user of the mobile communication device 104 deactivates the log by entering a digit sequence. For example, the user inputs “*4” and the network infrastructure component 102 deactivates the log. Once deactivated, the network infrastructure component 102 will not enter phone numbers for calls terminated to and/or originated by the mobile communication device 104, as will be appreciated by those skilled in the art.

Where the log is activated, the user of the mobile communication device 104 in one example inputs a privacy digit sequence to temporarily deactivate the log for the next outgoing call. For example, the user inputs “*2” followed by a phone number. The network infrastructure component 102 determines that the privacy digit sequence has been entered and omits the phone number from the log, as described herein.

The network infrastructure component 102 in one example determines an authorization of the user of the mobile communication device 104 before performing the management procedures. For example, the user input a digit sequence to initiate a management procedure. The network infrastructure component 102 then requires the user to input a password digit sequence to continue the procedure, as will be appreciated by those skilled in the art.

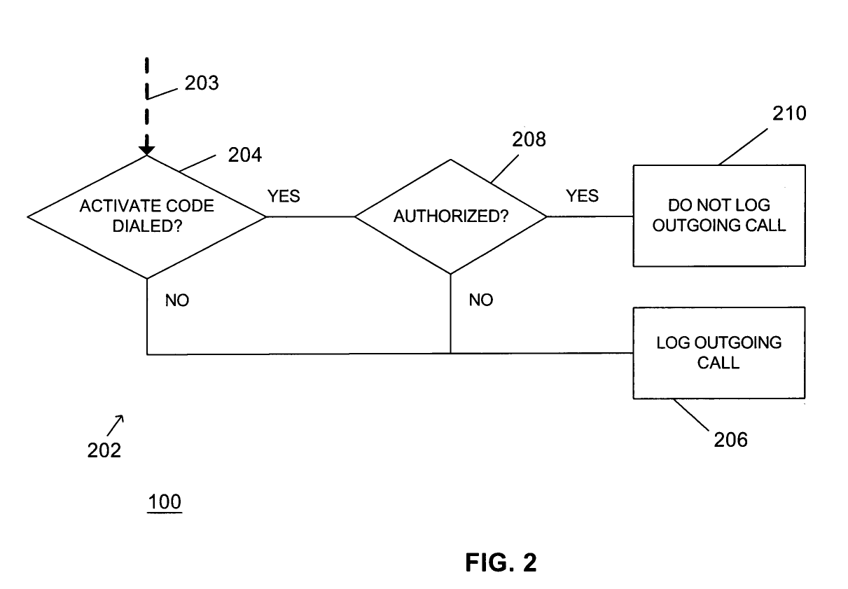

Turning to FIG. 2, an exemplary call flow 202 comprises a call flow for an outgoing call 203 that is blocked from the log. The user of the mobile communication device 104 in one example inputs a privacy digit sequence to block the call from the log, a password digit sequence to authorize the block, and a phone number to call. The mobile communication device 104 sends one or more messages to the network infrastructure component 102 to initiate the outgoing call 203. The messages comprise the privacy digit sequence, the password digit sequence, and the phone number.

The network infrastructure component 102 determines that the log is activated, for example, the network infrastructure component 102 queries the mobile subscriber database 108 to obtain the activation status of the log. The network infrastructure component 102 employs the messages to determine if the privacy digit sequence was entered by the user (STEP 204). If the privacy digit sequence was not entered, the network infrastructure component 102 creates an entry for the outgoing call 203 in the log (STEP 206). If the privacy digit sequence was entered, the network infrastructure component 102 determines if the user has authorization to block the outgoing call 203. For example, the network infrastructure component 102 determines if the password digit sequence matches a pre-determined authorization digit sequence (STEP 208). If the privacy digit sequence does not match the pre-determined authorization digit sequence, the network infrastructure component 102 creates the entry for the outgoing call 203 in the log (STEP 206). If the privacy digit sequence matches the pre-determined authorization digit sequence, the network infrastructure component 102 places the outgoing call 203 and does not create an entry in the log. In alternative implementations, the authorization of STEP 206 is not required, as will be appreciated by those skilled in the art.

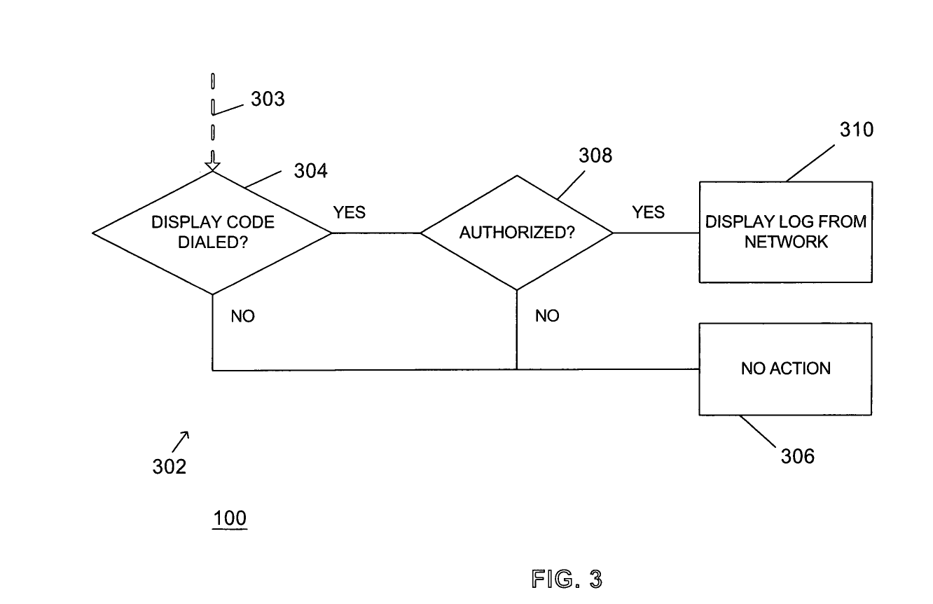

Turning to FIG. 3, an exemplary call flow 302 comprises a request 303 for displaying the log. The user of the mobile communication device 104 in one example inputs a display digit sequence to request the log and a password digit sequence to authorize the request 303. The mobile communication device 104 sends one or more messages to the network infrastructure component 102 to initiate the request 303. The messages comprise the display digit sequence and the password digit sequence.

The network infrastructure component 102 employs the messages to determine if the display digit sequence was entered by the user (STEP 304). If the display digit sequence was not entered, the network infrastructure component 102 disregards the request 303 (STEP 306). If the display digit sequence was entered, the network infrastructure component 102 determines if the user has authorization to display the log. For example, the network infrastructure component 102 determines if the password digit sequence matches a pre-determined authorization digit sequence (STEP 308). If the privacy digit sequence does not match the pre-determined authorization digit sequence, the network infrastructure component 102 disregards the request 303 (STEP 306). If the privacy digit sequence matches the pre-determined authorization digit sequence, the network infrastructure component 102 cooperates with the mobile communication device 104 to display the log to the user. In alternative implementations, the authorization of STEP 306 is not required, as will be appreciated by those skilled in the art.

The apparatus 100 in one example comprises a plurality of components such as one or more of electronic components, hardware components, and computer software components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art.

The apparatus 100 in one example employs one or more computer-readable signal-bearing media. Examples of a computer-readable signal-bearing medium for the apparatus 100 comprise the recordable data storage medium 110 of the network infrastructure component 102, the recordable data storage medium 110 of the mobile communication device 104, and the recordable data storage medium 110 of the mobile subscriber database 108. For example, the computer-readable signal-bearing medium for the apparatus 100 comprises one or more of a magnetic, electrical, optical, biological, and atomic data storage medium. In one example, the computer-readable signal-bearing medium comprises a modulated carrier signal transmitted over a network comprising or coupled with the apparatus 100, for instance, one or more of a telephone network, a local area network (“LAN”), the internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. An apparatus, comprising:
a network infrastructure component that allows a user of a mobile communication device to perform one or more management procedures on a log of one or more calls terminated to and/or originated by the mobile communication device.

2. The apparatus of claim 1, wherein the log comprises one or more entries that comprise one or more of:
a phone number associated with a call, wherein the phone number comprises a dialed number if the call is originated by the mobile communication device or a caller ID number if the call is terminated to the mobile communication device; and/or
a duration of the call.

3. The apparatus of claim 2, wherein the network infrastructure component sends one or more messages to the mobile communication device at an end of the call to manage the log.

4. The apparatus of claim 2, wherein the one or more management procedures comprise procedures for one or more of:
removal of one or more selected entries of the one or more entries from the log;
removal of all of the one or more entries from the log; and/or
insertion of one or more entries into the log.

5. The apparatus of claim 2, wherein the one or more management procedures comprise a procedure for protected access to the log.

6. The apparatus of claim 5, wherein the procedure for protected access to the log requires a password and/or digit sequence to access the log.

7. The apparatus of claim 2, wherein the one or more management procedures comprise a procedure for activation and/or deactivation of the log.

8. The apparatus of claim 1, wherein the user of the mobile communication device employs a digit sequence to initiate one or more of the one or more management procedures on the log.

9. The apparatus of claim 1, wherein the network infrastructure component comprises a mobile subscriber database that stores the log.

10. The apparatus of claim 1, wherein the network infrastructure component obtains an activation status of the log from a mobile subscriber database.

11. A method, comprising the steps of:
managing a log of one or more calls terminated to and/or originated by a mobile communication device through employment of a mobile subscriber database of a mobile communications network.

12. The method of claim 11, wherein the step of managing the log of the one or more calls terminated to and/or originated by the mobile communication device through employment of the mobile subscriber database of the mobile communications network comprises the step of:
sending one or more messages to the mobile communication device at an end of a call to manage the log.

13. The method of claim 11, wherein the step of managing the log of the one or more calls terminated to and/or originated by the mobile communication device through employment of the mobile subscriber database of the mobile communications network comprises the step of:
removing one or more entries from and/or adding one or more entries to the log.

14. The method of claim 11, further comprising the step of:
activating and/or deactivating the log upon receiving a message from a user of the mobile communication device.

15. The method of claim 14, further comprising the step of:
receiving a digit sequence from the user of the mobile communication device to cause an activation and/or deactivation of the log.

16. The method of claim 11, further comprising the step of:
querying the mobile subscriber database to determine an activation status of the log.

17. The method of claim 11, wherein the step of managing the log of the one or more calls terminated to and/or originated by the mobile communication device through employment of the mobile subscriber database of the mobile communications network comprises the steps of:
receiving a request for an outgoing call;
determining an activation status of the log based on the request;
determining an authorization of a user of the mobile communication device based on the request; and
performing a log management procedure based on the log activation status and/or the authorization.

18. The method of claim 17, wherein the step of performing the log management procedure based on the log activation status and/or the authorization comprises one or more of the steps of:
inserting an entry into the log; and/or
displaying the log to the user of the mobile communication device.

19. An article, comprising:
one or more computer-readable signal-bearing media; and
means in the one or more media for managing a log of one or more calls terminated to and/or originated by a mobile communication device through employment of a mobile subscriber database of a mobile communications network.

20. The article of claim 19, further comprising:
means in the one or more media for activating and/or deactivating the log upon receiving a message from a user of the mobile communication device.
